(19) United States
(12) Patent Application Publication
(10) Pub. No.: US 2004/0231102 A1
(43) Pub. Date: Nov. 25, 2004

(54) Ergonomic handle for a carrying case

(75) Inventors: Josh Morenstein, San Francisco, CA (US); Gad Amit, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands, Inc., Lincolnshire, IL

(21) Appl. No.: 10/762,205

(22) Filed: Jan. 20, 2004

Related U.S. Application Data
(60) Provisional application No. 60/440,999, filed on Jan. 17, 2003.

(51) Int. Cl. E05B 1/00

(52) U.S. Cl. 16/114.1

(57) ABSTRACT

An ergonomic handle that includes a male portion and a female portion. The male portion nest in the female portion to form a single, preferably rigid, form. The stiffness of the handle spreads the load of the case more evenly across all the fingers thereby helping to reduce fatigue.

### CROSS-REFERENCES TO RELATED APPLICATIONS

This application claims priority from Provisional Application No. 60/440,999, filed Jan. 17, 2003, the disclosure of which is incorporated herein by reference.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to an ergonomic handle and more particularly, to an ergonomic handle that includes a male side and a female side that nest together to form a single rigid form.

2. Description of the Prior Art

People carry many types of carrying cases or bags in today's busy society. Such bags often include computer carrying cases, briefcases, luggage, etc. In today's hectic business world, people often have to travel, whether it be a short distance or a long distance, and require many different things in order to do their work or function at meetings or even give presentations. Since people use these bags to carry all types of materials, including computers, the bags or cases that people carry can become quite heavy. Thus, it is desirable to provide ergonomically appropriate features with today's carrying cases, bags, luggage, etc.

### BRIEF SUMMARY OF THE INVENTION

Broadly the present invention provides an ergonomic handle that includes a male side and a female side. The male side nests in the female side to form a single, preferably rigid, form. The stiffness of the handle spreads the load of the case more evenly across all the fingers thereby helping to reduce fatigue.

More particularly, the present invention provides a handle for a carrying case. The handle includes a first portion that comprises an upper portion and a lower portion. The upper portion defines a receiving area and the lower portion defines a first carrying case engagement portion. The handle further includes a second portion that comprises an upper portion and a lower portion, with the upper portion defining a nesting part that nests within the receiving area when the handle is in use. The lower portion defines a second carrying case engagement portion. The nesting part pivots within the receiving area.

In accordance with one aspect of the present invention, the first and second carrying case portions each comprise a single elongated portion that is received by the carrying case.

In accordance with another aspect of the present invention, the first and second carrying case portions each comprise two individual parts that are received by the carrying case.

In accordance with yet another aspect of the present invention, the first portion may be separated from the second portion.

In accordance with a further aspect of the present invention, the nesting part is secured within the receiving area.

The present invention also provides a carrying case that comprises a body, at least two handle engagement portions and a handle. The handle includes a first portion that comprises an upper portion and a lower portion. The upper portion defines a receiving area and the lower portion defines a first carrying case engagement portion that engages at least one of the at least two handle engagement portions. The handle also includes a second portion that comprises an upper portion and a lower portion. The upper portion defines a nesting area that nests within the receiving area when the handle is in use. The lower portion defines a second carrying case engagement portion that engages at least one of the at least two handle engagement portions. The nesting part pivots within the receiving area.

The novel features that are characteristic of the present invention, as to organization and method of operation, together with further objects and advantages thereof will be better understood from the following description considered in connection with the accompanying drawings in which a preferred embodiment of the invention is illustrated by way of example. It is to be expressly understood, however, that the drawings are for the purpose of illustration and description only and are not intended as a definition of the limits of the invention.

### BRIEF DESCRIPTION OF THE DRAWINGS

FIG. 1A is a perspective view of an ergonomic handle in accordance with its present invention;

FIG. 1B is a perspective view of an ergonomic handle in accordance with the present invention in a closed and narrow orientation;

FIG. 2 is a perspective view of an ergonomic handle in accordance with the present invention in a closed and wide orientation;

FIG. 3 is a sectional view of an ergonomic handle in accordance with the present invention; and

FIG. 4 is a perspective view an alternative embodiment of an ergonomic handle in accordance with the present invention.

### DESCRIPTION OF THE PREFERRED EXEMPLARY EMBODIMENTS

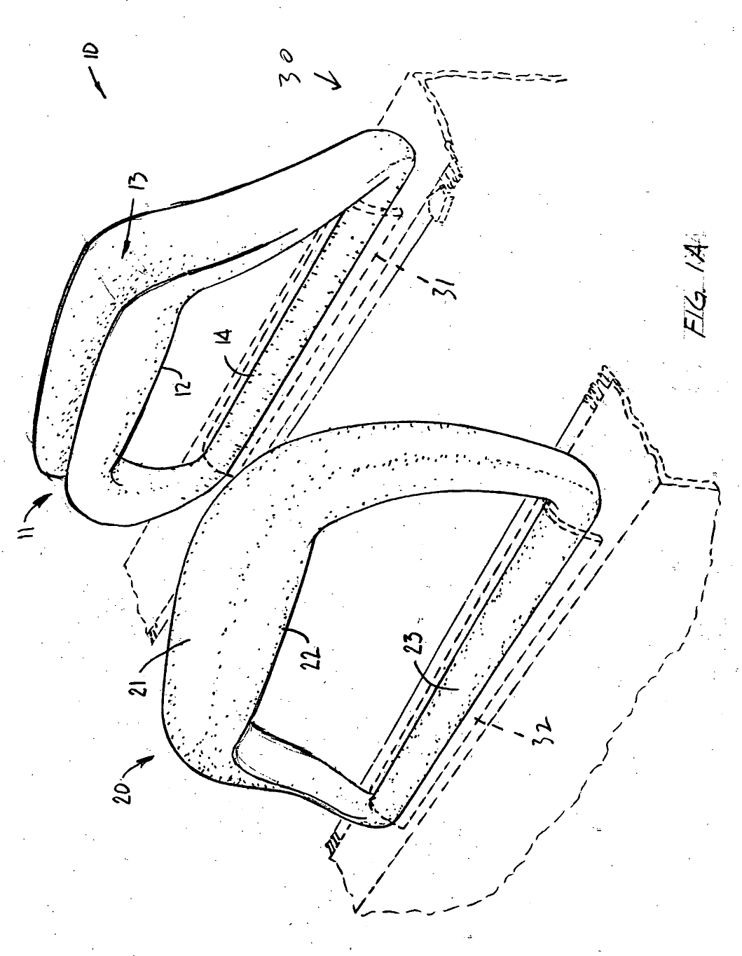

FIG. 1A illustrates a first portion or female component 11 for an ergonomic handle 10 in accordance with the present invention. As can be seen in the figures, an upper portion 12 of the female component includes a receiving area in the form of a groove or trench 13 defined therein. A bottom portion 14 is configured to be coupled to a bag or carrying case 30. The bottom portion may be coupled with straps or by being placed into a receiving portion 31 of the bag. Those skilled in the art will understand that other arrangements for coupling to a bag are also possible.

FIG. 1A also illustrates a second portion or male component 20 for the ergonomic handle in accordance with the present invention. As can be seen, an upper portion 21 of the male component is fairly “full” and preferably includes a rounded central portion 22, preferably at least the bottom of which is rounded. A bottom portion 23 of the male component includes a portion for attaching or coupling to bag or carrying case 30. The bottom portion may be coupled with straps or by being placed into a receiving portion 32 of the bag.

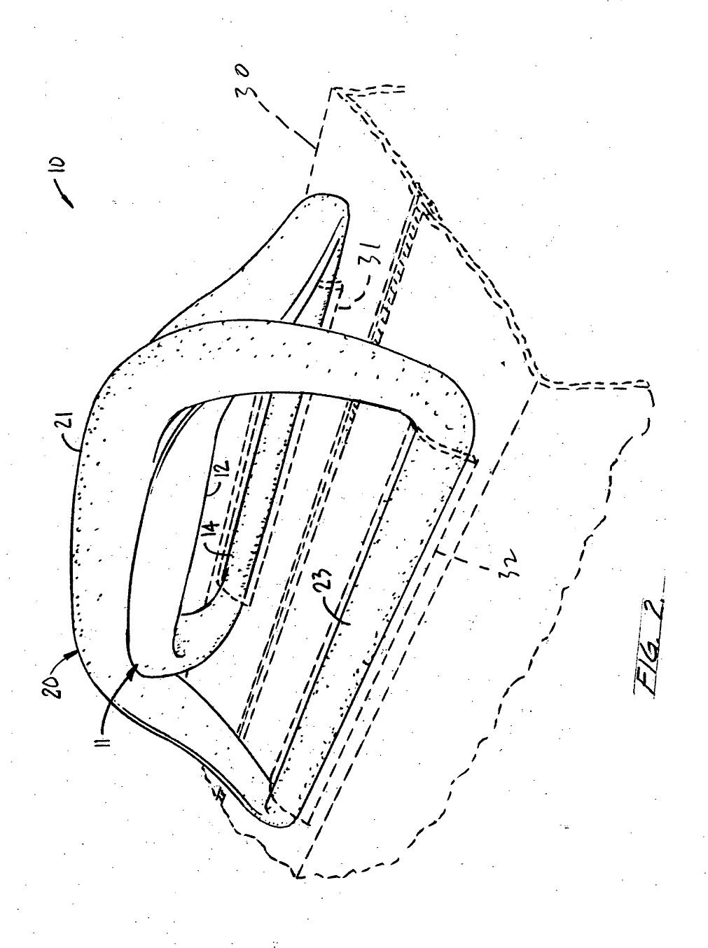

As may be seen in FIGS. 1B-4, the male component nests with the female component. As may be seen, upper portion 21 of the male component nests or rests within groove or trench 13 defined within the upper portion of the female component.

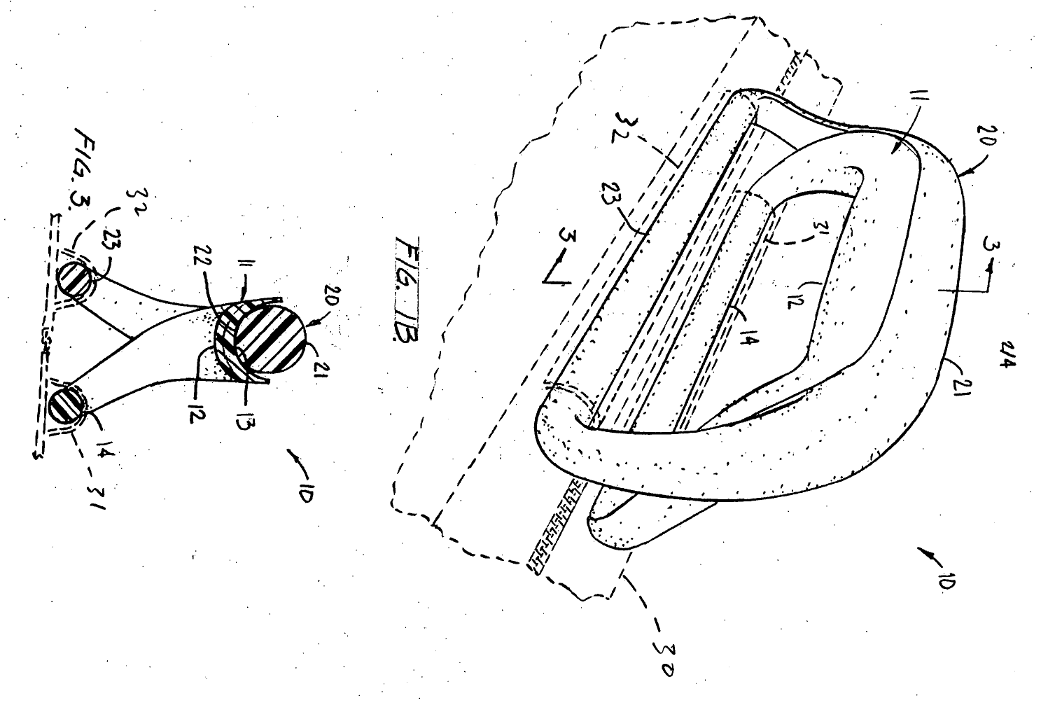

FIG. 1B provides a perspective view of a narrow orientation of the ergonomic handle. FIG. 2 illustrates the ergonomic handle in a wider orientation. This is achieved by the male upper portion pivoting within the female upper portion. By allowing the handle to pivot, the handle is able to accommodate a case width range of 1-5 inches at the location where the handle is coupled to the bag (i.e., the bag may be wider than 5 inches). This allows for a wide range of applications for the narrowest of laptop sleeves to much larger roller cases. Furthermore, the handle is well suited for expandable bags. Thus, an ergonomic handle in accordance with the present invention has a wide range of uses for various bags including, for example, computer carrying cases, briefcases, filecases, luggage, etc.

Preferably, the handle is made of a rigid material such as plastic, wood, metal, etc. A soft covering may be placed over some or all of the handle components to provide comfort to the user.

The handle may be configured such that the trench walls extend up and over the male upper portion. This would allow the male upper portion to be substantially secured within the female upper portion with a snap-fit type connection.

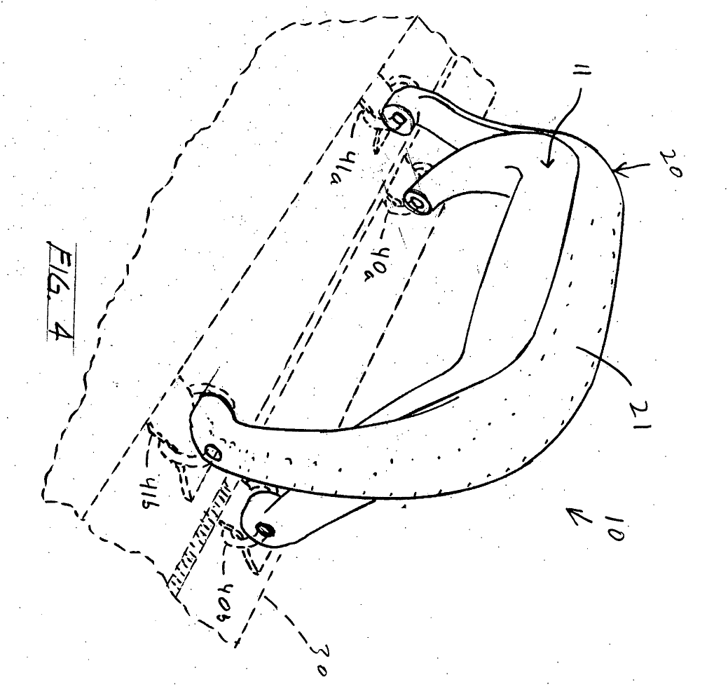

FIG. 4 illustrates an alternative embodiment where the handle portions are each coupled to carrying case 30 at two points 40a,b and 41a,b. Those skilled in the art will understand that there are other configurations that may be used to couple the carrying case to the handle.

Examples of dimensions for the handle include an overall length of 6.30 inches for the female portion and an overall length of 6.70 inches for the male portion. The handle has an overall height of 2.80 inches for the female portion and 3.25 inches for the male portion. The trench has a radius of curvature of 0.435 inches while the male upper portion has a diameter 0.87 inches. These dimensions are merely illustrative and those skilled in the art will realize that they may be changed depending upon the desired size of the handle, the size of the carrying case, the amount of spread capability desired for the handle, etc.

The above-described arrangements of apparatus and methods are merely illustrative of applications of the principles of this invention and many other embodiments and modifications may be made without departing from the spirit and scope of the invention as defined in the claims.

What is claimed is:

1. A handle for a carrying case, the handle comprising:
a first portion comprising an upper portion and a lower portion, the upper portion defining a receiving area and the lower portion defining a first carrying case engagement portion; and
a second portion comprising an upper portion and a lower portion, the upper portion defining a nesting part that nests within the receiving area when the handle is in use and the lower portion defining a second carrying case engagement portion;
wherein the nesting part pivots within the receiving area.

2. A handle in accordance with claim 1 wherein the first and second carrying case portions each comprise a single elongated portion that is received by the carrying case.

3. A handle in accordance with claim 1 wherein the first and second carrying case portions each comprise two individual parts that are received by the carrying case.

4. A handle in accordance with claim 1 wherein the first portion may be separated from the second portion.

5. A handle in accordance with claim 1 wherein the nesting part is secured within the receiving area.

6. A carrying case comprising a body, at least two handle engagement portions and a handle, the handle comprising:
a first portion comprising an upper portion and a lower portion, the upper portion defining a receiving area and the lower portion defining a first carrying case engagement portion that engages at least one of the at least two handle engagement portions; and
a second portion comprising an upper portion and a lower portion, the upper portion defining a nesting part that nests within the receiving area when the handle is in use and the lower portion defining a second carrying case engagement portion that engages at least one of the at least two handle engagement portions;
wherein the nesting part pivots within the receiving area.

7. A carrying case in accordance with claim 6 wherein the carrying case comprises two handle engagement portions and the first and second carrying case portions each comprise a single elongated portion that is received by a respective handle engagement portion.

8. A carrying case in accordance with claim 6 wherein the carrying case comprises four handle engagement portions and the first and second carrying case portions each comprise two individual parts that engage two respective handle engagement portions.

9. A carrying case in accordance with claim 6 wherein the first portion may be separated from the second portion.

10. A carrying case in accordance with claim 6 wherein the nesting part is secured within the receiving area.

11. A method of varying dimensions of a carrying case comprising a body, at least two handle engagement portions and a handle, the method comprising:
providing the handle comprising:
a first portion comprising an upper portion and a lower portion, the upper portion defining a receiving area and the lower portion defining a first carrying case engagement portion that engages at least one of the at least two handle engagement portions; and
a second portion comprising an upper portion and a lower portion, the upper portion defining a nesting part that nests within the receiving area when the handle is in use and the lower portion defining a second carrying case engagement portion that engages at least one of the at least two handle engagement portions;
wherein the nesting part pivots within the receiving area;
varying a width of the body; and
pivoting the nesting part within the receiving area in order to move the carrying case engagement portions to accommodate the width of the body.

12. An ergonomic handle for bags, carrying cases and the like, the handle comprising a male portion and a separate female portion, wherein the male portion nests within the female portion and is capable of pivoting relative thereto.
